(19) United States
(12) Patent Application Publication
(10) Pub. No.: US 2007/0126217 A1
(43) Pub. Date: Jun. 7, 2007

(54) Front and side impact air bag arrangements

(75) Inventor: Ayad G. Nayef, Sterling Heights, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/292,243

(22) Filed: Dec. 1, 2005

(51) Int. Cl. B60R 21/205

(52) U.S. Cl. 280/732; 280/730.2

(57) ABSTRACT

An apparatus (10) helps protect an occupant (20, 24) of a vehicle (12) that has an instrument panel (70) and a side structure (82, 122). The apparatus (10) includes a frontal air bag (30, 100) inflatable from a stored position rearward in the vehicle (12) to a deployed position between the instrument panel (70) and the vehicle occupant (20, 24). The apparatus (10) also includes a side air bag (60, 130) inflatable from a stored position in the instrument panel (70) to a deployed position between the side structure (82, 122) and the vehicle occupant (20, 24). A first inflator (34) is actuatable to provide inflation fluid for inflating the frontal air bag (30, 100). A second inflator (104) is separate from the first inflator (34) and is actuatable to provide inflation fluid for inflating the side air bag (60, 130).

### FIELD OF THE INVENTION

The present invention relates to an inflatable vehicle occupant protection device for helping to protect an occupant of a vehicle upon the occurrence of an event for which occupant protection is desired, such as a vehicle collision.

### BACKGROUND OF THE INVENTION

It is known to provide an inflatable vehicle occupant protection device, such as an air bag, for helping to protect an occupant of a vehicle. One type of air bag is a frontal air bag inflatable between an occupant of a front seat of the vehicle and an instrument panel of the vehicle. Frontal air bags include driver side air bags inflatable from a stored position in a vehicle steering wheel. Frontal air bags also include passenger side air bags inflatable from a stored position in an instrument panel of the vehicle.

Another type of inflatable vehicle occupant protection device is a side air bag inflatable between an occupant of a driver side or passenger side vehicle seat and a side structure of the vehicle adjacent the seat. Side air bags are inflated from a stored position in the vehicle seat or the side structure (e.g., a side door or pillar) of the vehicle.

A further type of inflatable vehicle occupant protection device is an inflatable curtain inflatable between a driver side or passenger side vehicle seat and an adjacent side structure of the vehicle. Inflatable curtains are inflated from a stored position adjacent the intersection of the side structure and the vehicle roof.

### SUMMARY OF THE INVENTION

The present invention relates to an apparatus for helping to protect an occupant of a vehicle that has an instrument panel and a side structure. The apparatus includes a frontal air bag inflatable from a stored position rearward in the vehicle to a deployed position between the instrument panel and the vehicle occupant. The apparatus also includes a side air bag inflatable from a stored position in the instrument panel to a deployed position between the side structure and the vehicle occupant. A first inflator is actuatable to provide inflation fluid for inflating the frontal air bag. A second inflator is separate from the first inflator and is actuatable to provide inflation fluid for inflating the side air bag.

The present invention also relates to an apparatus including a frontal air bag module and a side air bag module. The frontal air bag module includes a first housing, a frontal air bag having a stored position in the first housing, and a first inflator. The first inflator inflates the frontal air bag from the stored position to a deployed position between an instrument panel of the vehicle and the vehicle occupant. The frontal air bag module is installed in the instrument panel or a steering wheel of the vehicle. The side air bag module includes a second housing, a side air bag having a stored position in the second housing, and a second inflator. The second inflator inflates the side air bag from the stored position to a deployed position between the side structure and the vehicle occupant. The side air bag module is installed in the instrument panel.

The present invention further relates to an apparatus for helping to protect an occupant of a vehicle that has a driver side, a passenger side, a side structure on the driver side, a side structure on the passenger side, and an instrument panel extending across the vehicle from the driver side to the passenger side. The apparatus includes a driver frontal air bag module including a driver frontal air bag and a first inflator for inflating the driver frontal air bag between the instrument panel a driver side vehicle occupant. The driver frontal air bag module is installed in one of the instrument panel and a steering wheel of the vehicle. The apparatus also includes a driver side air bag module including a driver side air bag and a second inflator for inflating the driver side air bag between the side structure on the driver side and the driver side vehicle occupant. The driver side air bag module is installed in the instrument panel. The apparatus also includes a passenger frontal air bag module including a passenger frontal air bag and a third inflator for inflating the passenger frontal air bag between the instrument panel and a passenger side vehicle occupant. The passenger frontal air bag module is installed in the instrument panel of the vehicle. The apparatus also includes a passenger side air bag module including a passenger side air bag and a fourth inflator for inflating the passenger side air bag between the side structure on the passenger side and the passenger side vehicle occupant. The passenger side air bag module is installed in the instrument panel. The apparatus further includes means for selectively actuating one or more of the first, second, third, and fourth inflators in response to sensing the occurrence of an event for which occupant protection is desired.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic side view illustrating a driver side implementation of an apparatus for helping to protect an occupant of a vehicle, according to the present invention;

FIG. 2 is a schematic side view illustrating a passenger side implementation of an apparatus for helping to protect an occupant of a vehicle, according to the present invention;

FIG. 3 is a schematic front view illustrating an instrument panel of the vehicle including the apparatus of FIGS. 1 and 2;

FIG. 4 is a schematic top view illustrating the apparatus of FIGS. 1-3; and

FIG. 5 is a schematic block diagram of the apparatus of FIGS. 1-4.

### DESCRIPTION OF THE PREFERRED EMBODIMENTS

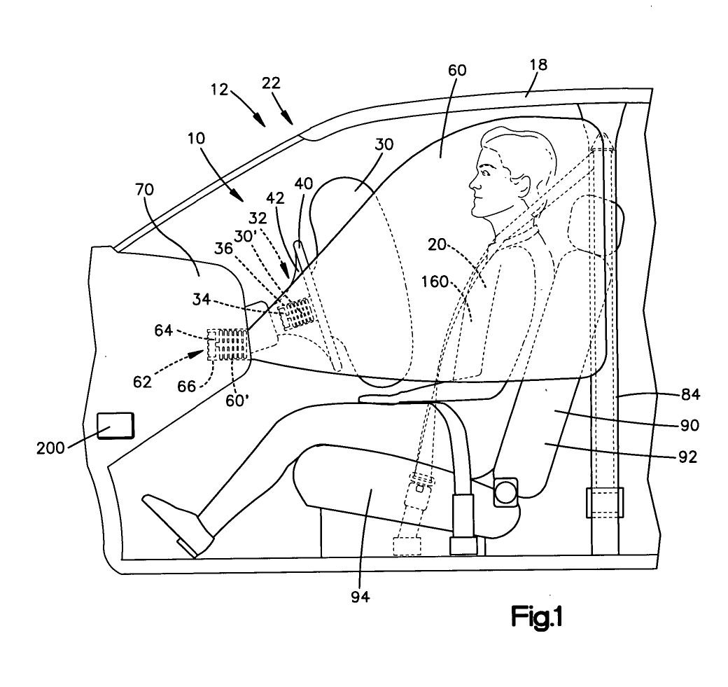

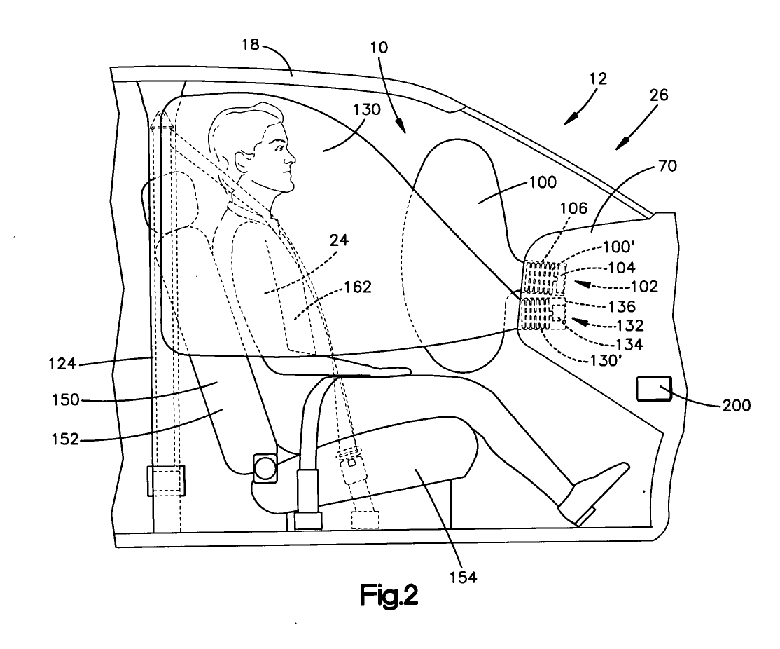

Referring to FIGS. 1 and 2, the present invention relates to an apparatus 10 for helping to protect an occupant of a vehicle 12. As shown in FIGS. 1 and 2, the apparatus 10 may help protect an occupant 20 (FIG. 1) of a driver side 22 of the vehicle 12, an occupant 24 (FIG. 2) of a passenger side 26 of the vehicle, or occupants of both the driver side and passenger side of the vehicle.

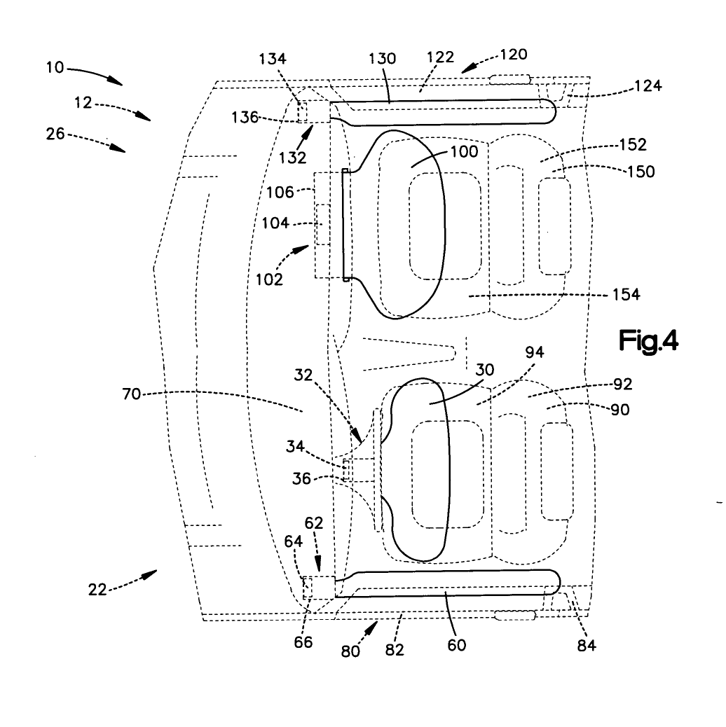

Referring to FIG. 4, the vehicle 12 includes a side structure 80 on the driver side 22 of the vehicle 12 and a side structure 120 on the passenger side 26 of the vehicle. The side structure 80 on the driver side 22 includes a driver side door 82 and a B pillar 84. The side structure 120 on the passenger side 26 includes a passenger side door 122 and a B pillar 124. The vehicle 12 also includes an instrument panel 70 that extends across in the vehicle 12 from the side structure 80 on the driver side 22 to the side structure 120 on the passenger side 26.

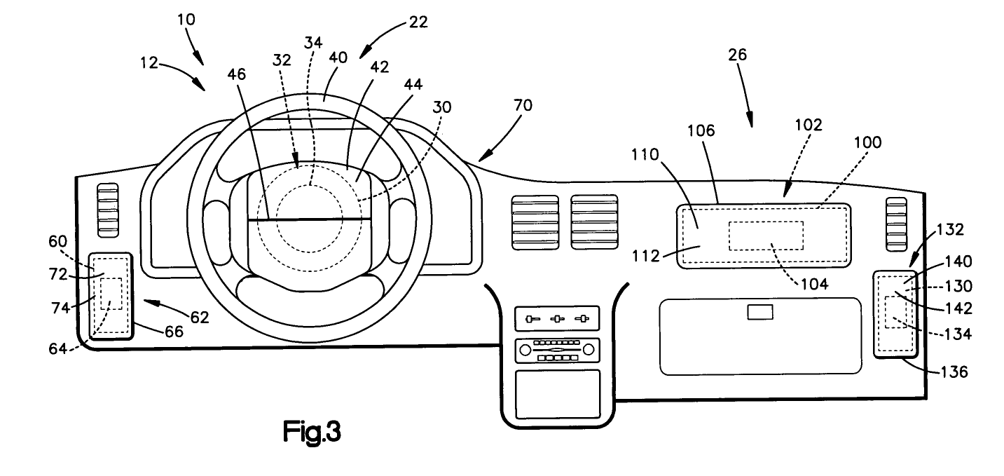

Referring to FIGS. 1, 3 and 4, on the driver side 22 of the vehicle 12, the apparatus 10 includes a driver frontal air bag 30. The driver frontal air bag 30 is inflatable from a stored position illustrated in FIGS. 1 and 3 to a deployed position illustrated in FIGS. 1 and 4. In FIG. 1, the stored position of the driver frontal air bag is shown in dashed lines at 30′ and the deployed position is shown on solid lines at 30. The apparatus 10 also includes a driver side air bag 60. The driver side air bag 60 is inflatable from a stored position illustrated in FIGS. 1 and 3 to a deployed position illustrated in FIGS. 1 and 4. In FIG. 1, the stored position of the driver side air bag is shown in dashed lines at 60′ and the deployed position is shown on solid lines at 60.

The driver frontal air bag 30 may be a part of a driver frontal air bag module 32 that includes an inflation fluid source 34, such as an inflator, and a housing 36. In the stored position, the driver frontal air bag 30 is folded and placed in the housing 36. The driver frontal air bag module 32 is secured on a steering wheel 40 of the vehicle 12. For example, the driver frontal air bag module 32 may be secured to a hub 42 of the steering wheel 40 and concealed with a cover 44 (FIG. 3) that includes means, such as a tear seam 46, for allowing the cover to open upon inflation of the driver frontal air bag 30.

The driver side air bag 60 may be a part of a driver side air bag module 62 that includes an inflation fluid source 64, such as an inflator, and a housing 66. In the stored position, the driver side air bag 60 is folded and placed in the housing 66. The driver side air bag module 62 is secured to the instrument panel 70 on the driver side 22 of the vehicle 12. For example, the driver side air bag module 62 may be secured to the instrument panel 70 adjacent or near the vehicle side structure 80, e.g., adjacent or near the driver side door 82 (FIG. 4) of the vehicle 12.

The driver side air bag module 62 may be concealed in the instrument panel 70 by a cover 72 (FIG. 3) that includes means for allowing the cover to open. For example, the cover 72 may comprise a door 74 of the housing 66 that is adapted to open upon inflation of the driver side air bag 60.

Referring to FIGS. 2-4, on the passenger side 26 of the vehicle 12, the apparatus 10 includes a passenger frontal air bag 100. The passenger frontal air bag 100 is inflatable from a stored position illustrated in FIGS. 2 and 3 to a deployed position illustrated in FIGS. 2 and 4. In FIG. 2, the stored position of the passenger frontal air bag is shown in dashed lines at 100′ and the deployed position is shown on solid lines at 100. The apparatus 10 also includes a passenger side air bag 130. The passenger side air bag 130 is inflatable from a stored position illustrated in FIGS. 2 and 3 to a deployed position illustrated in FIGS. 2 and 4. In FIG. 2, the stored position of the passenger side air bag is shown in dashed lines at 130′ and the deployed position is shown in solid lines at 130.

The passenger frontal air bag 100 may be a part of a passenger frontal air bag module 102 that includes an inflation fluid source 104, such as an inflator, and a housing 106. In the stored position, the passenger frontal air bag 100 is folded and placed in the housing 106. The passenger frontal air bag module 102 is secured to the instrument panel 70 on the passenger side 26 of the vehicle 12. The passenger frontal air bag module 102 may be concealed in the instrument panel 70 by a cover 110 (FIG. 3) that includes means for allowing the cover to open. For example, the cover 110 may comprise a door 112 of the housing 106 that is adapted to open upon inflation of the passenger frontal air bag 100.

The passenger side air bag 130 may be a part of a passenger side air bag module 132 that includes an inflation fluid source 134, such as an inflator, and a housing 136. In the stored position, the passenger side air bag 130 is folded and placed in the housing 136. The passenger side air bag module 132 is secured in the instrument panel 70 on the passenger side 26 of the vehicle 12. For example, the passenger side air bag module 132 may be secured to the instrument panel 70 adjacent or near the vehicle side structure 120, e.g., adjacent or near the passenger side door 122 (FIG. 4) of the vehicle 12. The passenger side air bag module 132 may be concealed in the instrument panel 70 by a cover 140 (FIG. 3) that includes means for allowing the cover to open. For example, the cover 140 may comprise a door 142 of the housing 136 that is adapted to open upon inflation of the passenger side air bag 130.

The inflation fluid sources 34, 64, 104 and 134 may comprise any means suitable to provide inflation fluid for inflating their respective air bags 30, 60, 100, and 130. For example, the inflators 34, 64, 104 and 134 may contain a stored quantity of pressurized inflation fluid (not shown) in the form of a gas for inflating the air bags 30, 60, 100 and 130. The inflators 34, 64, 104 and 134 alternatively could contain a combination of pressurized inflation fluid and ignitable material for heating the inflation fluid, or could be pyrotechnic inflators that use the combustion of gas-generating material to generate inflation fluid. As a further alternative, the inflators 34, 64, 104 and 134 could be of any suitable type or construction for supplying a medium for inflating the air bags 30, 60, 100 and 130.

The air bags 30, 60, 100, and 130 may have any suitable construction. For example, the air bags 30, 60, 100, and 130 may include panels of material that are arranged in an overlying manner. Portions of the panels are secured together via connections (not shown) to help define inflatable volumes of the air bags 30, 60, 100, and 130. These connections may be formed in a variety of manners, such as by weaving the panels as a single piece of material, stitching the panels together, or interconnecting the panels by ultrasonic welding, heat bonding, or adhesives.

The air bags 30, 60, 100, and 130 may also include connections that help define non-inflatable portions of the air bags to help further define their inflatable volumes. The configuration of the air bags 30, 60, 100, and 130, as defined by the overall shape of the air bags and the configuration of their respective inflatable volumes, may vary depending on a variety of factors, such as the architecture of the vehicle 12, the position of the air bags in the vehicle, and the desired extent or coverage of the air bags.

The panels used to construct the air bags 30, 60, 100, and 130 are woven from any suitable material, such as nylon yarn. The panels may be coated with a gas impermeable material, such as urethane, or laminated with a gas impermeable film. The air bags 30, 60, 100, and 130 thus may have a substantially gas-tight construction. Those skilled in the art will appreciate that alternative materials, such as polyester yarn, and alternatives coatings, such as silicone, may also be used to construct the air bags 30, 60, 100, and 130.

The vehicle 12 includes one or more sensor mechanisms 200 (shown schematically in FIGS. 1 and 2) for sensing the occurrence of an event for which inflation of one or more of the air bags 30, 60, 100, and 130 may be desired. Examples of such events include front impact events, side impact events, offset impact events, angled impact events, and vehicle rollover events. Upon sensing the occurrence of an event for which inflation of one or more of the air bags is desired, the sensor mechanism 200 is operative to provide one or more signals indicative of the event. One or more of the inflators 34, 64, 104, and 134 may be actuated in response to the signals provided by the sensor mechanism 200. This is described in greater detail below.

Once actuated, the inflators 34, 64, 104, and 134 discharge inflation fluid under pressure into their respective air bags 30, 60, 100, and 130. The air bags 30, 60, 100, and 130 inflate under the pressure of the inflation fluid from the inflators 34, 64, 104, and 134. Their respective housings 36, 66, 106, and 136 open and the air bags 30, 60, 100, and 130 inflate away from the instrument panel in a direction generally rearward in the vehicle 12 as viewed in FIGS. 1-4 to their respective deployed positions.

The driver frontal air bag 30, when in the deployed position, is positioned between the driver side occupant 20 and the instrument panel 70 and also between the occupant 20 and the steering wheel 40. The driver frontal air bag 30, when in the deployed position, terminates in front of a torso 160 of the driver side occupant 20 in a normally seated position. In the deployed position, the driver frontal air bag 30 is positioned generally above a seat bottom 94 of a driver side seat 90 of the vehicle 12 and forward of a seat back 92 of the seat. The driver frontal air bag 30 covers the steering wheel 40 and portions of the instrument panel 70 on the driver side 22 of the vehicle 12.

The driver side air bag 60, when in the deployed position, is positioned between the driver side occupant 20 and the side structure 80 (e.g., the side door 82) on the driver side 22 of the vehicle 12. In the deployed position, the driver side air bag 60 may extend rearward along the side structure 80 above the seat bottom 94 between the seat back 92 and the side structure. The driver side air bag 60 may extend rearward of the seat back 92 and may also cover a portion of the B pillar 84 on the driver side 22 of the vehicle 12.

The passenger frontal air bag 100, when in the deployed position, is positioned between the passenger side occupant 24 and the instrument panel 70 on the passenger side 26 of the vehicle 12. The passenger frontal air bag 100, when in the deployed position, terminates in front of a torso 162 of the passenger side occupant 24 in a normally seated position. In the deployed position, the passenger frontal air bag 100 is positioned generally above a seat bottom 154 of a passenger side seat 150 of the vehicle 12 and forward of a seat back 152 of the seat. The passenger frontal air bag 100 covers portions of the instrument panel 70 on the passenger side 26 of the vehicle 12.

The passenger side air bag 130, when in the deployed position, is positioned between the passenger side occupant 24 and the side structure 120 (e.g., the side door 122) on the passenger side 26 of the vehicle 12. In the deployed position, the passenger side air bag 130 may extend rearward along the side structure 120 above the seat bottom 154 between the seat back 152 and the side structure. The passenger side air bag 130 may extend rearward of the seat back 152 and may also cover a portion of the B pillar 124 on the passenger side 26 of the vehicle 12.

The driver frontal air bag 30 and the driver side air bag 60, when in their respective deployed positions, help protect the occupant 20 by absorbing the energy of impacts with the air bags and distributing the impact energy over large areas of the air bags. The passenger frontal air bag 100 and the passenger side air bag 130, when in their respective deployed positions, help protect the occupant 24 by absorbing the energy of impacts with the air bags and distributing the impact energy over large areas of the air bags.

According to the present invention, mounting the driver side air bag module 62 and the passenger side air bag module 132 to the instrument panel 70 provides advantages over seat, door, and roof mounted side air bag module configurations. The side air bags 60 and 130, being deployed from the instrument panel 70, may cover extended portions of the side structures 80 and 120. The portions covered by the side air bags 60 and 130 extend from adjacent the instrument panel 70 rearward in the vehicle 12 to adjacent the occupants 20 and 24. On the driver side 22 of the vehicle 12, the driver side air bag 60 may cover the side structure 80 from adjacent the instrument panel 70 rearward to adjacent or beyond the seat back 92, B pillar 84, or both. Similarly, on the passenger side 26 of the vehicle 12, the passenger side air bag 130 may cover the side structure 120 from adjacent the instrument panel 70 rearward to adjacent or beyond the seat back 152, B pillar 124, or both.

Also, the instrument panel 70 may be more readily adjusted to receive the modules 62 and 132 than the roof 18 and side doors 82 and 122. This is because the side doors 82 and 122 may include certain structure, such as side windows, window hardware, window motors, and window controls, that cannot be moved or otherwise adapted to permit mounting the modules 62 and 132 to the doors. Adapting the roof 18 to receive an air bag or side curtain module may not be desirable because doing so may affect the headroom in the vehicle 12. The instrument panel 70, on the other hand, may include structure, such as ductwork and wiring, that may be readily configurable or adaptable to receive or connect with the side air bag modules 62 and 132.

Furthermore, mounting the side air bag modules 62 and 132 in the instrument panel 70 may locate the modules more remotely from the occupants 20 and 24, respectively. Initial deployment of the side air bags 60 and 130 thus may take place remotely from the occupants 20 and 24. This may be desirable, for example, in the case of an occupant positioned away from a normally seated position, such as where the occupant is leaning against the side structure.

According to the present invention, the air bags 30, 60, 100, and 130 of the apparatus 10 may be actuatable separately and individually. Upon the occurrence of an event for which inflation of one or more of the air bags 30, 60, 100, and 130 is desired, a determination may be made as to which of the air bags to deploy and the timing at which the selected air bags are deployed. These determinations may depend, for example, on the type of event sensed by the sensor mechanism 200 or on data received from other vehicle condition sensors.

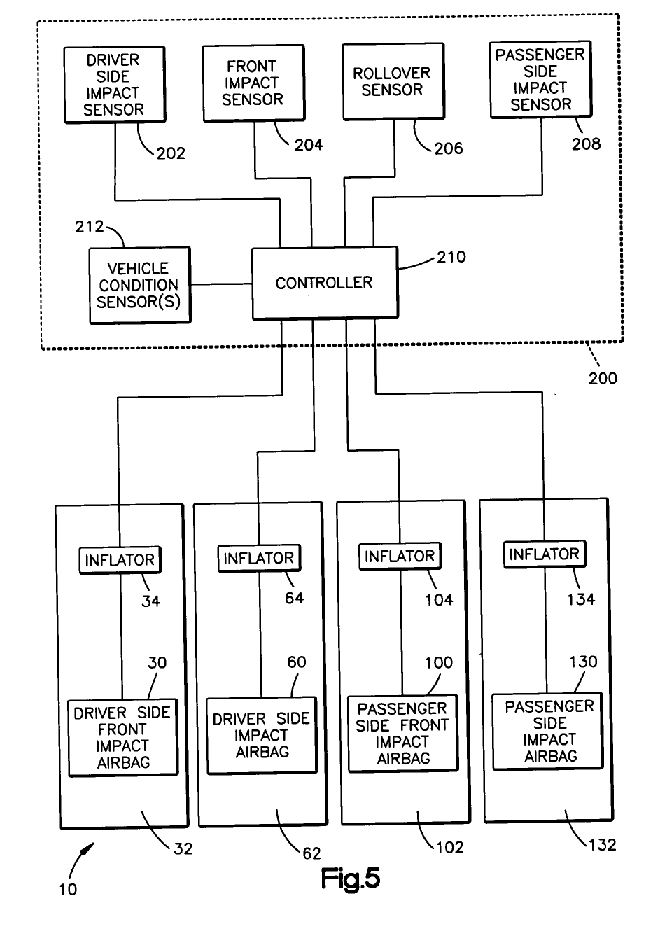

FIG. 5 illustrates an example of a sensor mechanism 200 that may be implemented in the apparatus 10. The sensor mechanism 200 includes a driver side impact sensor 202 operable to sense the occurrence of driver side impact events. The sensor mechanism 200 also includes a front impact sensor 204 operable to sense the occurrence of vehicle front impact events. The sensor mechanism 200 also includes a rollover sensor 206 operable to sense the occurrence of vehicle rollover events. The sensor mechanism 200 further includes a passenger side impact sensor 208 operable to sense the occurrence of passenger side impact events.

The sensors 202, 204, 206, and 208 are operatively connected to a central controller 210. The controller 210 is operative to receive signals from the sensors 202, 204, 206, and 208 related to the respective events that they sense. The driver side and passenger side impact sensors 202 and 208 are operable to provide signals to the controller 210 related to sensed driver side and passenger side impact events, respectively. The front impact sensor 204 is operable to provide a signal to the controller 210 related to sensed front impact events. The rollover sensor 206 is operable to provide a signal to the controller 210 related to sensed vehicle rollover events.

The controller 210 is operative to actuate the air bag modules 32, 62, 102, and 132 in response to the signals received from the sensors 202, 204, 206, and 208. For example, in response to a signal from the driver side impact sensor 202, the controller 210 may provide a signal to the driver side air bag module 62 to actuate the inflator 64 to inflate the driver side air bag 60. As another example, in response to a signal from the front impact sensor 204, the controller 210 may provide a signal to the driver frontal air bag module 32 to actuate the inflator 34 to inflate the driver frontal air bag 30 and also provide a signal to the passenger frontal air bag module 102 to actuate the inflator 104 to inflate the passenger frontal air bag 100. As a further example, in response to a signal from the rollover sensor 206, the controller 210 may provide a signal to the driver side air bag module 62 to actuate the inflator 64 to inflate the driver frontal air bag 60 and also provide a signal to the passenger side air bag module 132 to actuate the inflator 134 to inflate the passenger side air bag 130.

The sensor mechanism 200 may be configured in a variety of manners. For example, the sensors 202, 204, 206, and 208 may be adapted to provide signals to the controller 201 that are indicative of the magnitude of the respective events that they are configured to sense. In this instance, the controller 210 may be adapted to compare the magnitude of sensed events to stored values (e.g., in a look-up table) in order to determine whether the magnitude reaches a threshold at which actuation of one or more air bag modules 32, 62, 102, and 132 is warranted. The controller 210 would then actuate the appropriate module or modules 32, 62, 102, and 132.

As another example, the sensor mechanism 200 may be configured such that the sensors 202, 204, 206, and 208 provide signals to the controller 210 only upon detecting the occurrence of an event having a predetermined magnitude. In this instance, the controller 210 may be adapted to actuate one or more of the air bag modules 32, 62, 102, and 132 immediately upon receiving the appropriate signal. For example, the front impact sensor may provide a signal to the controller 210 only upon sensing the occurrence of a front impact having a magnitude at or above a predetermined threshold. The controller 210 may actuate the frontal air bag modules 30 and 100 in direct response to receiving the signal without making any other determinations.

As another example, the sensor mechanism 200 may be configured with multiple controllers instead of a single central controller 210. In one configuration, the sensor mechanism 200 may include redundant controllers, redundant sensors, or both. In another configuration, the sensor mechanism 200 may be configured to include separate controllers associated with the air bag modules 32, 62, 102, and 132. In another configuration, one controller may be used to control the frontal air bag modules 30 and 100 and another controller may be used to control the side air bag modules 62 and 132. In a further configuration, the controller 210 may be omitted and the sensors 202, 204, 206, and 208 may provide actuation signals directly to their respective modules 32, 62, 102, and 132.

As a further example, the sensor mechanism 200 may be configured such that the air bag modules 32, 62, 102, and 132 may be actuated separately or together, depending on the sensed event. For example, the controller 210 may be configured such that, in the event of a front impact, both of the frontal air bag modules 32 and 102 are actuated. In the event of a driver side impact, the driver side air bag module 62 only may be actuated, or both the driver side front and side air bag modules 32 and 62 may be actuated. In the event of a passenger side impact, the passenger side air bag module 132 only may be actuated, or both the passenger side front and side air bag modules 102 and 132 may be actuated. In the event of a vehicle rollover, the side air bag modules 62 and 132 only or both the side air bag modules and the frontal air bag modules 32 and 102 may be actuated.

As shown in FIG. 5, the sensor mechanism 200 may also include one or more vehicle condition sensors 212 that provide data related to sensed vehicle conditions to the controller 210. The vehicle condition sensors 212 may be operative to sense a variety of conditions of the vehicle, a vehicle occupant, or both. For example, the vehicle condition sensors 212 may include occupant position sensors, seat position sensors, seat belt latch sensors, seat weight sensors, seat belt tension sensors, or any other sensors that may be useful in determining whether to actuate the air bag modules 32, 62, 102, and 132.

For example, the vehicle condition sensors 212 may provide signals to the controller 200 indicating that an occupant is in a normal seated position and restrained by a vehicle seat belt. If this situation is detected, the controller 210 may be operative to actuate the air bag modules 32, 62, 102, and 132 based on the signals provided by the sensors 202, 204, 206, and 208, as described above. As another example, the vehicle condition sensors 212 may provide signals to the controller 210 indicating that an occupant is in a normal seated position but not restrained by a vehicle seat belt. If this situation is detected, the controller 210 may be operative to alter the timing of air bag inflation, inhibit air bag venting, or alter the actuation of multiple stage inflators to provide a high level of energy absorption for the unbelted occupant. As further example, a seatbelt tension sensor may be used to detect the presence of a child safety seat.

From the above description of the invention, those skilled in the art will perceive improvements, changes and modifications. Such improvements, changes and modifications within the skill of the art are intended to be covered by the appended claims.

Having described the invention, the following is claimed:

1. Apparatus for helping to protect an occupant of a vehicle having an instrument panel and a side structure, said apparatus comprising:
a frontal air bag;
a first inflator actuatable to provide inflation fluid for inflating said frontal air bag;
a side air bag; and
a second inflator separate from said first inflator and actuatable to provide inflation fluid for inflating said side air bag;
said frontal air bag being inflatable rearwardly in the vehicle from a stored position to a deployed position between the instrument panel and the vehicle occupant, said side air bag being inflatable rearwardly in the vehicle from a stored position in the instrument panel to a deployed position between the side structure and the vehicle occupant.

2. The apparatus recited in claim 1, wherein:
said frontal air bag when in said deployed position extends from the instrument panel toward the vehicle occupant and terminates forward of the occupant's torso; and
said side air bag when in said deployed position extends from the instrument panel to adjacent and rearward of the occupant's torso.

3. The apparatus recited in claim 1, wherein:
said frontal air bag when in said deployed position extends from the instrument panel toward a vehicle seat and terminates forward of a seat back of the vehicle seat; and
said side air bag when in said deployed position extends from the instrument panel to adjacent and rearward of the seat back of the vehicle seat.

4. The apparatus recited in claim 1, wherein said frontal air bag comprises a driver frontal air bag, the stored position being in a steering wheel of the vehicle.

5. The apparatus recited in claim 1, wherein said frontal air bag comprises a passenger frontal air bag, the stored position being in the instrument panel of the vehicle.

6. The apparatus recited in claim 1, wherein said first and second inflators are selectively and independently actuatable.

7. The apparatus recited in claim 1, further comprising means for selectively actuating said first and second inflators in response to sensing the occurrence of an event for which inflation of an air bag is desired.

8. The apparatus recited in claim 7, wherein said means for actuating is operable to actuate selectively one or both of said first and second inflators depending on at least one of the type of event sensed and sensed vehicle conditions.

9. The apparatus recited in claim 7, wherein said means for actuating is operable to actuate selectively said first and second inflators at different times depending on at least one of the type of event sensed and sensed vehicle conditions.

10. The apparatus recited in claim 1, wherein the stored position of said side air bag is located adjacent the intersection of the instrument panel and the side structure of the vehicle.

11. Apparatus for helping to protect an occupant of a vehicle, said apparatus comprising:
a frontal air bag module comprising a first housing, a frontal air bag having a stored position in said first housing, and a first inflator for inflating said frontal air bag from the stored position to a deployed position between an instrument panel of the vehicle and the vehicle occupant, said frontal air bag module being installed in one of the instrument panel and a steering wheel of the vehicle; and
a side air bag module comprising a second housing, a side air bag having a stored position in said second housing, and a second inflator for inflating said side air bag from the stored position to a deployed position between the side structure and the vehicle occupant, said side air bag module being installed in the instrument panel.

12. The apparatus recited in claim 11, further comprising means for selectively actuating said first and second inflators in response to sensing the occurrence of an event for which inflation of an air bag is desired.

13. The apparatus recited in claim 11, wherein said means for actuating is operable to actuate selectively one or both of said first and second inflators depending on at least one of the type of event sensed and sensed vehicle conditions.

14. The apparatus recited in claim 11, wherein said means for actuating is operable to actuate selectively said first and second inflators at different times depending on at least one of the type of event sensed and sensed vehicle conditions.

15. Apparatus for helping to protect an occupant of a vehicle that has a driver side, a passenger side, a side structure on the driver side, a side structure on the passenger side, and an instrument panel extending across the vehicle from the driver side to the passenger side, said apparatus comprising:
a driver frontal air bag module comprising a driver frontal air bag and a first inflator for inflating said driver frontal air bag between the instrument panel a driver side vehicle occupant, said driver frontal air bag module being installed in one of the instrument panel and a steering wheel of the vehicle;
a driver side air bag module comprising a driver side air bag and a second inflator for inflating said driver side air bag between the side structure on the driver side and the driver side vehicle occupant, said driver side air bag module being installed in the instrument panel;
a passenger frontal air bag module comprising a passenger frontal air bag and a third inflator for inflating said passenger frontal air bag between the instrument panel and a passenger side vehicle occupant, said passenger frontal air bag module being installed in the instrument panel of the vehicle;
a passenger side air bag module comprising a passenger side air bag and a fourth inflator for inflating said passenger side air bag between the side structure on the passenger side and the passenger side vehicle occupant, said passenger side air bag module being installed in the instrument panel; and
means for selectively actuating one or more of said first, second, third, and fourth inflators in response to sensing the occurrence of an event for which inflation of an air bag is desired.

16. The apparatus recited in claim 15, wherein said means for actuating is operable to actuate selectively at least one of said first, second, third, and fourth inflators based on at least one sensed vehicle condition.
